(19) United States
(12) Patent Application Publication
(10) Pub. No.: US 2026/0218854 A1
(43) Pub. Date: Jul. 30, 2026

(54) VESSEL FOR CONTAINING A PRESSURIZED GAS WITH IMPROVED ENDPIECE

(71) Applicant: PLASTIC OMNIUM NEW ENERGIES FRANCE, Lyon (FR)

(72) Inventors: Wilfried LEMASSON, Bruxelles (BE); Bjorn CRIEL, Bruxelles (BE)

(73) Assignee: PLASTIC OMNIUM NEW ENERGIES FRANCE, Lyon (FR)

(21) Appl. No.: 19/129,498

(22) PCT Filed: Dec. 7, 2023
(86) PCT No.: PCT/EP2023/084690

§ 371 Date: May 13, 2025

(30) Foreign Application Priority Data
Dec. 8, 2022 (FR) FR2213024

(51) Int. Cl. F17C 1/16

(52) U.S. Cl. CPC F17C 1/16; F17C 2201/0109; F17C 2203/012; F17C 2203/0604; F17C 2203/066; F17C 2209/2127; F17C 2209/22; F17C 2221/012; F17C 2270/0168

(57) ABSTRACT

A vessel including a liner having a neck, a reinforcing shell covering the liner, and an endpiece arranged in the neck. The vessel includes an axial opening, a first annular protrusion extending radially outwards with respect to the axial opening, a second annular protrusion extending radially outwards with respect to the axial opening, arranged axially outwards with respect to the first protrusion, and an outer axial end extending at least partially outside the vessel. The liner extends from the first annular protrusion to the second annular protrusion covering at least one portion of the first annular protrusion and the vessel includes a sealed contact surface between the endpiece and the neck extending between the first protrusion and the second protrusion, as well as a contact surface between the endpiece and the reinforcing shell, which extends axially between the second protrusion and the outer axial end.

The invention concerns vessels for containing pressurized gases, in particular on-board vessels in motor vehicles. The invention relates more specifically to a vessel for containing a pressurized gas and to a method of manufacturing a vessel for containing a pressurized gas. These gases include, but are not limited to, natural gas, biogas, liquefied petroleum gas and hydrogen.

The various functions of these vessels are to:
contain the gas under pressure, that is, resist mechanically,
ensure sealing from the outside,
fill with pressurized gas, using a solenoid valve mounted on the endpiece,
deliver pressurized gas using the same solenoid valve mounted on the endpiece,
attach to the supporting structure,
withstand conditions of transport and use,
withstand harmful environmental effects, external mechanical and thermal stresses,
withstand vessel manufacturing conditions.

These vessels can be mounted on all types of fixed or mobile equipment (road, rail, sea, air or space vehicles). Pressurized gas vessels are made of metal or, more recently, composite materials, for reasons of weight savings and safety.

Vessels made of composite materials, also known as composite vessels, are generally sealed by means of a container called a “liner”, capable of sealing the contents with regard to the container. Depending on the vessel manufacturer, liners are available in metal or plastic.

Thus, the “plastic” liner comprises at least one opening for filling and emptying the vessel. It is manufactured by injection or by rotational molding or by extrusion blow molding of a thermoplastic or thermosetting polymer (abbreviated to “thermoset”) such as for example polyethylene, polyamide, polyphthalamide, polyurethane, silicone, polyoxymethylene. Advantageously, the thermoplastic polymer material is filled with reinforcing fibers to form a composite material. The reinforcing fibers are, for example, glass fibers, carbon fibers, basalt fibers, aramid fibers, polymer fibers, silica fibers, polyethylene fibers, natural fibers, metal fibers, metal alloy fibers or ceramic fibers. These fibers increase the composite material's resistance to deformation. In a polymer material filled with reinforcing fibers, the reinforcing fibers and the polymer material are entangled to form a single-piece material. Such a composite material is described by the Applicant in its French patent application No. 18 72197 filed on Nov. 30, 2018 and published under No. 3,089,160.

This liner is then covered with a liner-reinforcing shell of composite material that forms the body of the vessel, that is, the vessel's resistant structure, which must be capable of withstanding the pressures exerted by the fluid contained in the vessel (hereinafter referred to as “internal pressure”). The reinforcing shell is generally not required to seal the vessel.

This reinforcing shell consists of:
a reinforcement generally made up of fibers, e.g., continuous fibers of glass, carbon, basalt, or others such as silica fibers or even plant fibers,
a resin which is either deposited at the same time as the fiber (filament-winding process) or after the shell has been produced to form a dry “preform”. This dry preform is then consolidated to give it the necessary rigidity. This consolidation is achieved by resin injection, resin infiltration through the preform (infusion process) or resin impregnation under vacuum.

Advantageously, the reinforcing shell is coated with one or more layers of a fire-retardant material, preferably an intumescent fire-retardant material such as, for example, a silicate or phosphate-based coating. Silicate and phosphate are intumescent agents which, after exposure to fire, expand to create an insulating barrier. This improves the vessel's resistance to heat and fire.

In every case, when the vessel is manufactured, an endpiece is sealingly assembled to the liner to enable filling and delivery of the fluid. The endpiece is generally made of metal (steel or aluminum). It is attached to a neck for filling/emptying the liner and has a flange for bearing against the liner. The endpiece also has a thread for mounting a solenoid valve thereupon. Such an endpiece is described in patent document U.S. Pat. No. 6,230,922.

When the reinforcing shell is applied to the liner using a filament-winding process, the liner is held in place by a robot arm or similar device at the endpiece. This can cause problems during the filament-winding process. The filament-winding process involves applying successive layers of helically and circumferentially wound fibers to the liner. If filament winding is carried out at high speed, a high torque is applied by the robot arm to the endpiece and to the connection between the endpiece and the liner, particularly during acceleration or deceleration phases that occur when applying layers of fibers wound along a helical path. With a liner made from polyamide 6(PA 6 ), a conventional screw connection between the endpiece and the liner generally provides resistance to a maximum torque of between 200 and 400 Nm; this resistance is lower with a liner made from high-density polyethylene (HDPE). To accelerate the speed of vessel manufacture, it is necessary to increase the torque resistance of the connection between the endpiece and the liner.

In order to increase this resistance, it is known to increase the axial span of the liner neck connected to the endpiece, in order to increase the connection surface between the endpiece and the liner neck. However, this results in an increase in the unusable volume of the vessel, that is, it increases the size of the vessel without increasing its capacity to store pressurized gas at the neck of the liner, which should be avoided given the limited space available in the vehicle. To prevent an increase in the unusable volume of the vessel, it is known to change the shape of the liner so that the neck of the liner is offset axially towards the inside of the vessel's internal volume. It is also known to change the shape of the liner so that the neck of the liner extends towards the inside of the inner volume of the vessel and not towards the outside of the inner volume of the vessel.

In both cases, the axial dimension of the vessel is reduced, thus reducing the overall dimensions of the vessel. But this comes with a drawback, in that it generates a concave area inside the vessel around the base of the neck, generally referred to as “dead volume”. The presence of this concave area considerably complicates the process of measuring the mechanical strength of the vessel, carried out in accordance with United Nations Economic Commission for Europe (UNECE) Regulation No. 134 on uniform provisions concerning the approval of motor vehicles and their components with regard to the safety requirements for hydrogen powered vehicles, under which pressurized fluid is injected into the vessel and the deformation of the vessel is measured. Once the process has been implemented, the vessel must be completely emptied of the fluid used. Emptying the concave area, which is difficult to access, is a particularly complex and time-consuming step, so it is preferable to avoid the presence of the concave area, or at least to reduce the volume of the concave area as much as possible. However, an increase in the axial span of the liner neck connected to the endpiece leads to an increase in the volume of the concave area.

Another solution for increasing resistance is to introduce glue between the endpiece and the liner, but this is a time-consuming operation that slows down the vessel manufacturing process and is difficult to control.

Know from documents US2008251520, US2007164561, WO2018002788 and WO2013008719 are vessels comprising a plastic liner, a neck surrounding an axial orifice of the liner, a reinforcing shell covering the liner, and an endpiece comprising a first annular protrusion and an outer axial end, the vessel comprising a sealing contact surface between the endpiece and the reinforcing shell which extends between the first annular protrusion and the axial end of the endpiece.

Also known from EP0810081 is a vessel comprising a plastic liner, a neck surrounding an axial orifice of the liner, a reinforcing shell covering the liner, and an endpiece comprising a first annular protrusion and an outer axial end. The vessel also comprises a seal between the neck and a pressure element that presses the seal against the endpiece and the liner.

One of the aims of the invention is to increase the strength of the connection between the endpiece and the liner, and to limit damage to the liner when the vessel is under pressure. Optimally, this increase in the torque resistance of the connection between the endpiece and the liner is achieved without increasing the size of the vessel or slowing down the vessel manufacturing process.

To this end, the object of the invention is a vessel intended to contain a pressurized gas comprising a plastic liner of generally cylindrical shape extending along a main axis, comprising a neck surrounding an axial orifice of the liner, a reinforcing shell covering the liner, and an endpiece extending along the main axis at least partially provided in the neck, the endpiece comprising at least:
an axial opening,
a first annular protrusion extending radially outwards from the vessel with respect to the axial opening,
a second annular protrusion extending radially outwards from the vessel with respect to the axial opening, the second annular protrusion being arranged axially outwards from the vessel with respect to the first annular protrusion, and
an outer axial end extending at least partly outside the vessel, characterized in that the liner extends from the first annular protrusion to the second annular protrusion, covering at least a portion of the first annular protrusion, and in that the vessel further comprises a sealing contact surface between the endpiece and the neck of the liner, which extends between the first annular protrusion and the second annular protrusion, as well as a contact surface between the endpiece and the reinforcing shell, which extends axially between the second annular protrusion and the axial end of the endpiece.

By “annular protrusion” of the endpiece is meant a section of the endpiece extending radially from the endpiece, and projecting beyond the endpiece so as to have a free upper axial surface and a free lower axial surface.

Thanks to the fact that the liner extends from the first annular protrusion (or first fin) to the second annular protrusion (or second fin), covering at least a portion of the first annular protrusion, the risk of damage to the liner due to the forces exerted on it by the endpiece when the vessel is under pressure, in an area close to the vessel opening, is limited. A good seal is also ensured at the vessel opening. In addition, thanks to the fact that the vessel comprises a sealed contact surface between the endpiece and the neck of the liner, which extends between the first annular protrusion and the second annular protrusion, the liner is sandwiched between, on the one hand, the endpiece and, on the other hand, the reinforcing shell in a contact area which forms a baffle, which makes it possible to further limit, in an area close to the opening of the vessel, the risks of damage to the liner. That is because, when the vessel is under pressure, static and dynamic forces are exerted on the neck of the liner by the endpiece. An example of liner damage due to static stress is creep of the liner plastic at the neck. An example of damage due to dynamic stress is fatigue of the liner plastic at the neck.

In addition to the above-mentioned risks of liner damage, excessive pressure in the vessel, for example during hydraulic cycling tests of the vessel as prescribed in United Nations Economic Commission for Europe (UNECE) Regulation No. 134, can lead to damage or even breakage of the endpiece. The invention also makes it possible to limit these risks.

Furthermore, the fact that a direct contact surface is provided between the endpiece and the reinforcing shell, extending axially between the second annular protrusion and the axial end of the endpiece, makes it possible to create an area, further away from the vessel opening, wherein, on the one hand, a good mechanical bond is created between the reinforcing shell and the endpiece and, on the other hand, the liner is not sandwiched between the endpiece and the reinforcing shell. The presence of such an area limits the risk of liner damage by the endpiece and the reinforcing shell. An example of liner damage is shearing of the liner by the endpiece and the reinforcing shell. Another example of liner damage is plastic creep.

In this way, the invention has the advantage of limiting the risk of liner damage in the area of the vessel opening, while limiting the risk of liner damage by the endpiece and the reinforcing shell, in particular by shearing of the liner by the endpiece and reinforcing shell. Thus, by increasing the strength of the connection between the endpiece and the liner, damage to the liner when the vessel is under pressure is prevented, all without increasing the size of the vessel or slowing down the vessel manufacturing process.

In a preferred embodiment, the liner neck extends axially outwards from the vessel with respect to the axial orifice of the liner. This creates a contact surface between the liner neck and the reinforcing shell, which extends between the first annular protrusion and the second annular protrusion. This arrangement ensures that the reinforcing shell takes up the forces exerted on the liner neck by the endpiece when the vessel is under pressure.

In a preferred embodiment, the first annular protrusion is integral with the endpiece. On the one hand, this simplifies vessel manufacture by limiting the number of additional parts and avoiding their attachment, and on the other, it improves the seal between the endpiece and the liner.

In a preferred embodiment, the second annular protrusion is also integral with the endpiece. On the one hand, this simplifies vessel manufacture by limiting the number of additional parts and avoiding their attachment, and on the other, it improves the seal between the endpiece and the liner.

In a particular embodiment, the outer axial end of the endpiece is not part of the second annular protrusion of the endpiece and vice versa, that is, they are not a direct area or extension of each other. In this case, the reinforcing shell completely covers the second annular protrusion, thereby increasing the contact surface between the endpiece and the reinforcing shell and ensuring good mechanical contact between these two elements.

In one variant, the outer axial end of the endpiece forms part of the second annular protrusion of the endpiece. In this case, the reinforcing shell only partially covers the second annular protrusion.

Preferably, the axial end of the endpiece is an annular protrusion in the above sense.

In order to further limit the risk of liner damage and further improve sealing at the vessel opening, according to a particular embodiment, the liner covers at least a portion of the second annular protrusion.

To further limit the risk of liner damage and further improve sealing at the vessel opening, the liner completely covers the first annular protrusion.

Preferably, the contact surface between the endpiece and the reinforcing shell extends axially from the second annular protrusion to the axial end of the endpiece. This increases the contact surface between the endpiece and the reinforcing shell, and ensures good mechanical contact between the two.

According to a preferred embodiment, a larger diameter of the first annular protrusion is less than or equal to a larger diameter of the second annular protrusion, preferably strictly less than a larger diameter of the second annular protrusion. This minimizes the weight of the endpiece by reducing its size.

According to a particular embodiment, a larger diameter of the first annular protrusion is strictly greater than a larger diameter of the second annular protrusion. This enables the endpiece to better resist breakage during hydraulic cycling tests of the vessel in accordance with United Nations Economic Commission for Europe (UNECE) Regulation No. 134.

According to a particular embodiment, the endpiece further comprises an inner axial end, opposite the outer axial end, which extends at least partially inside the vessel. This enables the useful volume of the vessel to be maximized in a restricted environment.

According to a particular embodiment, the endpiece further comprises a third annular protrusion (or third fin) extending radially outwards from the vessel with respect to the axial opening, the third annular protrusion being arranged axially outwards from the vessel with respect to the second annular protrusion. This allows the reinforcing shell to better absorb the forces exerted on the liner neck by the endpiece when the vessel is under pressure.

In a preferred embodiment, the third annular protrusion is also integral with the endpiece. On the one hand, this simplifies vessel manufacture by limiting the number of additional parts and avoiding their attachment, and on the other, it improves the seal between the endpiece and the liner.

According to a particular embodiment, a larger diameter of the third annular protrusion is smaller than that of the second annular protrusion. This minimizes the weight of the endpiece.

According to a particular embodiment, the endpiece further comprises an annular shoulder extending radially outwards from the vessel with respect to the axial opening, the annular shoulder being arranged axially outwards from the vessel with respect to the third annular protrusion.

Preferably, the endpiece further comprises an external anchoring surface selected from the group comprising a roughened surface, a surface that is not rotationally symmetrical about the main axis, an adhesive surface and a combination of these surfaces, the external anchoring surface of the endpiece being a sealing contact surface between the endpiece and the neck of the liner and/or a contact surface between the endpiece and the reinforcing shell. The presence of such an external anchoring surface strengthens the mechanical connection between the endpiece and the liner neck, thereby increasing the torque resistance of this connection. This makes it possible to implement a fast filament-winding process involving significant acceleration and deceleration phases, and thus to reduce the time and cost of vessel manufacture.

A surface that is not rotationally symmetrical about the main axis is meant as one whose cross-section in a plane perpendicular to the main axis is non-circular. Examples include a flat surface, a cross-sectional surface with a polygonal contour, e.g., hexagonal, toothed, crenellated, grooved, elliptical, etc.

The invention also relates to a method for manufacturing a vessel for containing a pressurized gas, characterized in that it comprises the following steps:
supplying an endpiece extending along a main axis, comprising an axial opening, a first annular protrusion extending radially outwards from the vessel with respect to the axial opening, a second annular protrusion extending radially outwards from the vessel with respect to the axial opening, the second annular protrusion being intended to be arranged axially outwardly from the vessel with respect to the first annular protrusion, and an outer end intended to extend at least partially outwardly from the vessel;
manufacturing a generally cylindrical liner extending along an axis, the liner comprising a neck surrounding an axial orifice of the liner;
attaching the endpiece to the liner so that the endpiece is at least partially arranged in the neck of the liner and the neck extends along the main axis, and so as to create a sealing contact surface between the endpiece and the neck of the liner, which extends between the first annular protrusion and the second annular protrusion;
attaching a reinforcing shell to the liner and the endpiece so that the reinforcing shell covers the liner, and so as to create a contact surface between the endpiece and the reinforcing shell, which extends axially between the second annular protrusion and the axial end of the endpiece.

According to a particular embodiment, the liner is made of plastic and the endpiece comprises an external anchoring surface selected from the group comprising a roughened surface, a surface that is not rotationally symmetrical about the main axis, an adhesive surface and a combination of these surfaces, and wherein the step of attaching the endpiece to the liner comprises a step of overmolding the neck of the liner onto the external anchoring surface of the endpiece during the liner manufacturing step, the liner preferably being manufactured by extrusion blow molding. This simplifies vessel manufacture. In particular, the presence of the adhesive surface improves the tightness of the sealing contact surface between the endpiece and the neck of the liner.

According to another particular embodiment, the liner is made of plastic and the endpiece comprises an external anchoring surface selected from the group comprising a roughened surface, a non-rotationally symmetrical surface about the main axis, an adhesive surface and a combination of these surfaces, and wherein the step of attaching the endpiece to the liner comprises the following steps:
overmolding, onto the external anchoring surface of the endpiece, an intermediate layer of plastic material chemically compatible with the plastic material of the liner, the intermediate layer preferably being produced by injection molding,
overmolding of the liner neck onto the intermediate layer of plastic material during the liner manufacturing stage, the liner preferably being manufactured by extrusion blow molding.

By “chemically compatible” is meant that the first and second polymer materials each comprise chemical species that can be welded together without the need for additional material. In other words, chemically compatible polymeric materials are capable of intimately bonding to one another by fusion, and in particular of producing a molecular entanglement of polymeric chains between them. Molecular entanglement of this kind is brought about by the addition of heat at the point of contact.

Preferably, the roughened surface of the endpiece is obtained by a step selected from etching of the external anchoring surface of the endpiece, machining of the external anchoring surface of the endpiece, molding of the external anchoring surface of the endpiece, knurling of the external anchoring surface of the endpiece and a combination of these steps, wherein the non-rotationally symmetrical surface about the main axis of the endpiece is obtained by machining and/or molding the outer anchoring surface of the endpiece, and wherein the adhesive surface of the endpiece is obtained by depositing on the external anchoring surface of the endpiece an adhesive or by activating the external anchoring surface of the endpiece. The external anchoring surface of the endpiece can be etched, for example, using a chemical etchant or a laser. The adhesive surface of the endpiece can be deposited by spraying or injection molding. The external anchoring surface of the endpiece can be activated by plasma, laser or heating. Activation changes the surface tension of the external anchoring surface of the endpiece to create free radicals on this surface, which in turn create a covalent or Van der Waals bond with the liner plastic to promote mutual adhesion.

Preferably, as the reinforcing shell is made of a composite material comprising resin and reinforcing fibers, the step of attaching the reinforcing shell to the endpiece and liner is a step of filament-winding the reinforcing shell onto the liner and the endpiece during the reinforcing shell manufacturing step.

### BRIEF DESCRIPTION OF THE FIGURES

The invention will be better understood upon reading the following description, which is provided merely as example and with reference to the appended drawings, wherein:

FIG. 1 is a local cross-section along a median plane of the connection zone of a vessel designed to contain a pressurized gas according to a first embodiment of the invention;

FIG. 2 is a sectional view along plane II-II of FIG. 1;

FIG. 3 is a perspective view of the endpiece of the vessel shown in FIG. 1;

FIG. 4 is a bottom view of the endpiece in FIG. 3;

FIG. 5 is a local cross-section along a median plane of the connection zone of a vessel designed to contain a pressurized gas according to a second embodiment of the invention;

FIG. 6 is a local cross-section along a median plane of the connection zone of a vessel designed to contain a pressurized gas according to a third embodiment of the invention;

FIG. 7 is a local cross-section along a median plane of the connection zone of a vessel designed to contain a pressurized gas according to a fourth embodiment of the invention;

FIG. 8 is a sectional view along plane VIII-VIII of FIG. 7;

FIG. 9 is a perspective view of the endpiece of the vessel of FIG. 7;

FIG. 10 is a bottom view of the endpiece in FIG. 9;

FIG. 11 is a local cross-section along a median plane of the connection zone of a vessel designed to contain a pressurized gas according to a fifth embodiment of the invention;

FIG. 12 is a sectional view along plane XII-XII of FIG. 11;

FIG. 13 is a perspective view of the endpiece of the vessel of FIG. 11;

FIG. 14 is a bottom view of the endpiece of FIG. 13;

FIG. 15 is a local cross-section along a median plane of the connection zone of a vessel designed to contain a pressurized gas according to a sixth embodiment of the invention;

FIG. 16 is a sectional view along plane XVI-XVI of FIG. 15;

FIG. 17 is a perspective view of the endpiece of the vessel of FIG. 15;

FIG. 18 is a bottom view of the endpiece of FIG. 17.

### DETAILED DESCRIPTION

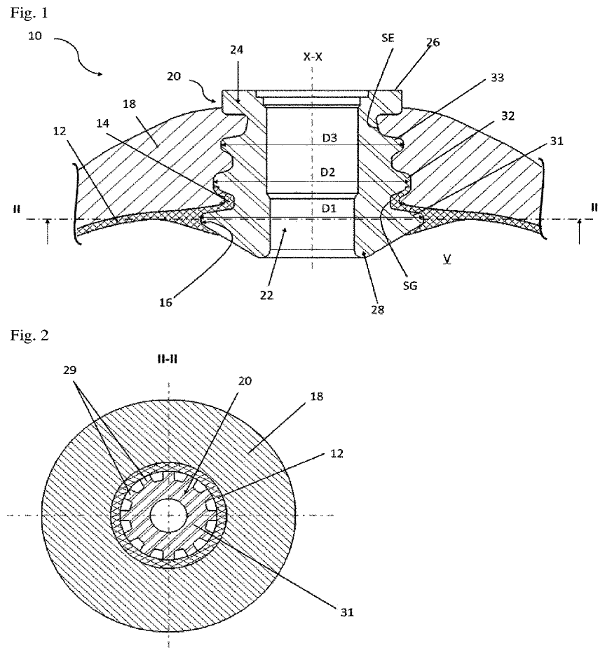

FIG. 1 shows part of a vessel 10 designed to contain a pressurized gas according to a first embodiment of the invention. The vessel 10 comprises a plastic liner 12 defining an internal volume V of the vessel designed to receive pressurized gas.

The liner 12 has a generally cylindrical or tubular central portion, with reference to a main axis X-X of the vessel 10, and two end parts, one of which is shown in FIG. 1. The end portion of the liner 12 shown comprises a neck 14 surrounding an axial orifice 16 of the liner 12 connecting the internal volume V of the vessel with the external environment, the neck 14 here extending outwards from the internal volume V. The liner 12 is preferably manufactured by injection, rotational molding or extrusion blow molding of a thermoplastic or thermoset polymer material, for example polyamide or polyethylene, and the thickness of the liner 12 is, for example, less than or equal to 5 mm.

The vessel 10 also comprises a reinforcing shell 18 covering the liner 12, preferably made of composite material, which forms the body of the vessel 10, that is, the resistant structure of the vessel 10.

The reinforcing shell 18 preferably comprises a reinforcement consisting of fibers, e.g., continuous, of glass, carbon, basalt, or others such as silica fibers or even vegetable fibers, and a resin which is either deposited at the same time as the fiber (e.g., by a filament winding process) or after the envelope has been made to form a dry “preform”. This dry preform is then consolidated to give it the necessary rigidity. This consolidation is achieved by resin injection, resin infiltration through the preform (infusion process) or resin impregnation under vacuum.

Advantageously, the reinforcing shell 18 is coated with one or more layers of a fire-retardant material, preferably an intumescent fire-retardant material such as, for example, a silicate or phosphate-based coating. Silicate and phosphate are intumescent agents which, after exposure to fire, expand to create an insulating barrier. This improves the heat and fire resistance of vessel 10.

The vessel 10 also comprises an endpiece 20 at least partially arranged in the neck 14 of the liner 12. The endpiece 20 comprises a generally rotationally symmetrical shape with respect to the main axis X-X. The endpiece 20 comprises a central portion extending partially inside neck 14 of liner 12 and a peripheral portion extending partially around neck 14 of liner 12 so that neck 14 of liner 12 is protected from the external environment by endpiece 20. The endpiece 20 is made of metal, such as aluminum. In particular, endpiece 20 is configured to accommodate a solenoid valve (not shown in the figures) for alternately filling and emptying gas from vessel 10.

In all the embodiments shown in the figures, the vessel 10 also comprises a sealed contact surface SG between the endpiece 20 and the neck 14 of the liner.

The endpiece 20 extends along the main axis X-X and is at least partially arranged in the neck 14. It has an axial opening 22 which extends along the main axis X-X and is, for example, substantially circular in cross-section.

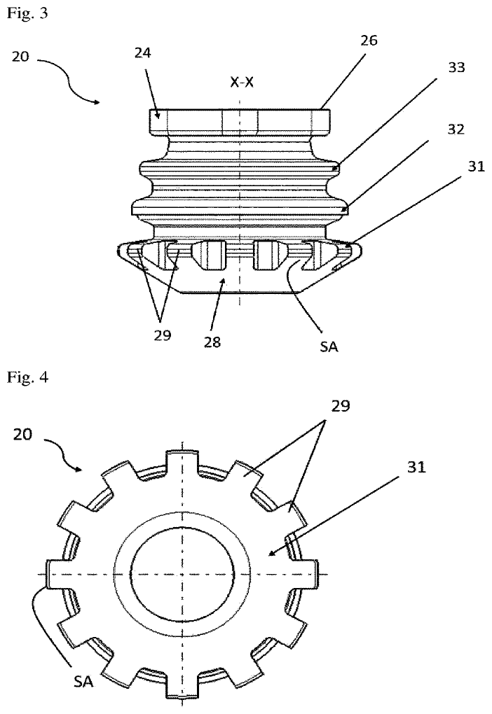

As can be seen in FIGS. 1 and 3, the endpiece 20 further comprises an outer axial end 24 extending at least partly outside the vessel 10. The adjective “external” here refers to the volume V of the vessel 10. The outer axial end 24 therefore lies outside the liner neck 14 and is not covered by the reinforcing shell 18. The outer axial end 24 comprises an annular shoulder 26 extending radially outwards from the vessel with respect to the axial opening 22.

The endpiece 20 further comprises an inner axial end 28, opposite the outer axial end 24, which extends at least partly inside the vessel 10. The adjective “inner” is used here to refer with respect to the volume V of vessel 10. The inner axial end 28 therefore lies outside the liner neck 14 and is not covered by the reinforcement shell 18. It is located within the volume V of vessel 10.

The endpiece 20 further comprises a first annular protrusion 31, or first fin 31, extending radially outwards from the vessel 10 with respect to the axial opening 22. Here, the first annular protrusion 31 is integral with the endpiece 20. By “annular protrusion” of the endpiece 20 is meant a section of the endpiece 20 extending radially from the endpiece 20, and projecting beyond the endpiece 20 so as to have a free upper axial surface and a free lower axial surface.

In the embodiments shown in the figures, the outer axial end 24 is in particular a protrusion within the meaning of this definition. However, as we will see later, this is just one example.

The first annular protrusion 31 is preferably radially symmetrical about the main axis X-X. Its radial contour is preferably continuously curved, that is, it has no sharp edges.

Preferably, endpiece 20 further comprises an external anchoring surface SA selected from the group comprising a rough surface, a surface that is not rotationally symmetrical about the main axis X-X, an adhesive surface and a combination of these surfaces.

A surface that is not rotationally symmetrical about the main axis X-X is one whose cross-section in a plane perpendicular to the main axis X-X is not circular. Examples include a flat surface, a cross-sectional surface with a polygonal contour, e.g., hexagonal, toothed, crenellated, grooved, elliptical, etc.

The presence of such an external anchoring surface SA strengthens the mechanical connection between the endpiece 20 and the neck 14 of the liner 12, thereby increasing the torque resistance of this connection.

In the first three embodiments shown in FIGS. 1 to 6, the first annular protrusion 31 carries such an external anchoring surface SA which is a rotationally unsymmetrical surface around the principal axis X-X.

Indeed, in these first three embodiments, the external anchoring surface SA locally has a cross-section, in a plane perpendicular to the axis X-X, in this case in the cross-sectional plane II-II, in the shape of a toothed wheel, as can be seen in FIGS. 2 to 4 in particular. That is, it comprises a plurality of teeth 29 projecting from the first annular protrusion 31 extending radially outwards from the vessel 10. Preferably, the teeth 29 are symmetrically distributed around the X-X axis. The number of teeth 29 on the wheel here is twelve, but this number can of course vary. The shape of the teeth 29 is also substantially rectangular in this II-II plane, but can also vary.

In these first three embodiments, the external anchoring surface SA is therefore formed by a succession of recesses (the spaces between the teeth 29) and protuberances (the teeth 29), thereby reinforcing the mechanical connection between the endpiece 20 and the neck 14 of the liner 12 and increasing the torque resistance of this connection.

Here, the external anchoring surface SA forms a portion of the sealed contact surface SG between neck 14 and endpiece 20, but it could form the entire sealed contact surface SG. The ratio between the external anchoring surface SA and the sealed contact surface SG between the endpiece 20 and the neck 14 can of course be varied as required.

The endpiece 20 also features a second annular protrusion 32, or second fin 32, extending radially outwards from the vessel 10 with respect to the axial opening 22. The second annular protrusion 32 is arranged axially outwards from the vessel 10 with respect to the first annular protrusion 31, that is, upwards in the figures with respect to the first annular protrusion 31. Here, the second annular protrusion 32 is integral with the endpiece 20.

In the embodiments shown in the figures, the outer axial end 24 of the endpiece is not part of the second annular protrusion 32 of the endpiece and vice versa, that is, they are not a direct area or extension of one another. In this case, the reinforcing shell 18 completely covers the second annular protrusion 32, thereby increasing the contact surface between the endpiece 20 and the reinforcing shell 18 and ensuring good mechanical contact between these two elements.

However, in a variant not shown, the outer axial end 24 of the endpiece forms part of the second annular protrusion 32 of the endpiece. In this case, the reinforcing shell 18 only partially covers the second annular protrusion 32.

The second annular protrusion 32 is preferably radially symmetrical about the main axis X-X. Its radial contour is preferably continuously curved, that is, it has no sharp edges. In all the embodiments shown in the figures, its cross-section in a plane perpendicular to axis X-X is substantially circular. Naturally, the shape of the second annular protrusion 32 can vary.

In the first embodiment of the invention shown in FIGS. 1 to 4, a larger diameter D1 of the first annular protrusion 31 is strictly greater than a larger diameter D2 of the second annular protrusion 32.

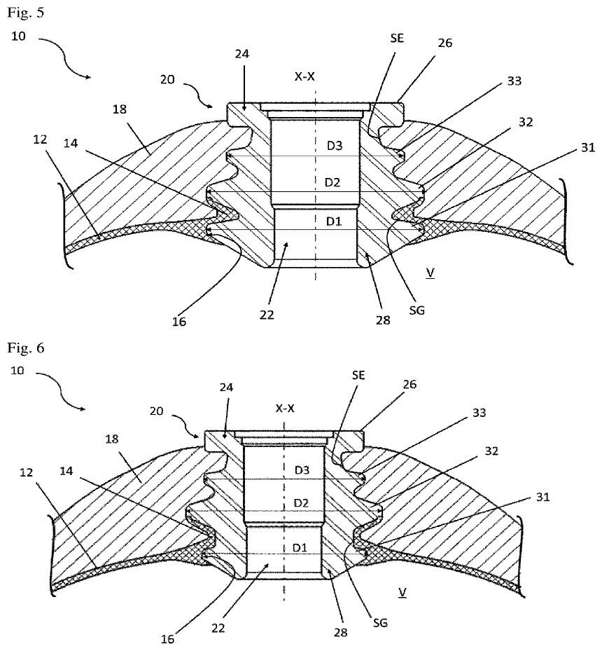

However, according to a second embodiment of the invention shown in FIG. 5, a larger diameter D1 of the first annular protrusion 31 is substantially equal to a larger diameter D2 of the second annular protrusion 32. The vessel 10 is otherwise identical to that of the first embodiment.

According to a third embodiment of the invention shown in FIG. 6, a larger diameter D1 of the first annular protrusion 31 is smaller than or equal to a larger diameter D2 of the second annular protrusion 32, preferably strictly smaller than a larger diameter of the second annular protrusion 32. The vessel 10 is otherwise identical to that of the first embodiment.

In all the embodiments shown in the figures, the sealing contact surface SG between the endpiece 20 and the neck 14 of the liner extends between the first annular protrusion 31 and the second annular protrusion 32, as can be seen in FIGS. 1, 5, 7, 11 and 15.

According to a particular embodiment, the endpiece further comprises a third annular protrusion (or third fin) 33 extending radially outwards from the vessel 10 with respect to the axial opening 22. The third annular protrusion 33 is arranged axially outwards from the vessel 10 with respect to the second annular protrusion 32, that is, towards the top of the figures with respect to the second annular protrusion 32. In this case, the third annular protrusion 33 is integral with the endpiece 20.

The third annular protrusion 33 is preferably radially symmetrical about the main axis X-X. Its radial contour is preferably continuously curved, that is, it has no sharp edges. In all the embodiments shown in the figures, its cross-section in a plane perpendicular to axis X-X is substantially circular. Naturally, the shape of the third annular protrusion 33 can vary.

In all the embodiments shown in the figures, a larger diameter D3 of the third annular protrusion 33 is smaller than that of the second annular protrusion 32, as can be seen in FIGS. 1, 5, 7, 11 and 15. However, it is possible to vary this diameter according to requirements.

In all the embodiments shown in the figures, the vessel 10 also comprises a contact surface SE between the endpiece 20 and the reinforcing shell 18, which extends axially between the second annular protrusion 32 and the outer axial end 24 of the endpiece 20, as can be seen in FIGS. 1, 5, 7, 11 and 15.

In all the embodiments shown in the figures, the neck 14 of the liner 12 extends axially outwards from the vessel 10 with respect to the axial orifice 16 of the liner 12. This creates a contact surface between the neck 14 of the liner 12 and the reinforcing shell 18, which extends between the first annular protrusion 31 and the second annular protrusion 32.

In all the embodiments shown in the figures, the liner 12 extends from the first annular protrusion 31 to the second annular protrusion 32, covering at least a portion of the first annular protrusion 31, as can be seen in FIGS. 1, 5, 7, 11 and 15. This further reduces the risk of damage to the liner 12 in an area close to the opening of the vessel 10, due to the forces exerted on the liner by the endpiece 20 when the vessel 10 is under pressure. A good seal is also ensured at the opening of vessel 10.

In order to further limit the risk of damage to the liner 12 and further improve sealing at the opening of the vessel 10, in all the embodiments shown in the figures, the liner 12 covers at least a portion of the second annular protrusion 32, as can be seen in FIGS. 1, 5, 7, 11 and 15.

In order to further limit the risk of damage to the liner 12 and further improve sealing at the opening of the vessel 10, in all the embodiments shown in the figures, the liner 12 completely covers the first annular protrusion, as can be seen in FIGS. 1, 5, 7, 11 and 15.

Preferably, the contact surface SE between endpiece 20 and reinforcing shell 18 extends axially from the second annular protrusion to the axial end of endpiece 20. This increases the contact surface SE between the endpiece 20 and the reinforcing shell 18 and ensures good mechanical contact between these two elements.

In a variant not shown in the figures, the external anchoring surface SA forms a portion of the contact surface SE between the endpiece 20 and the reinforcing shell 18, or the entire contact surface SE between the endpiece 20 and the reinforcing shell 18. In yet another variant not shown in the figures, the endpiece 20 comprises two external anchoring surfaces SA which respectively form a portion, or all, of the sealing contact surface SG between the neck 14 of the liner 12 and the endpiece 20 and of the contact surface SE between the endpiece 20 and the reinforcing shell 18.

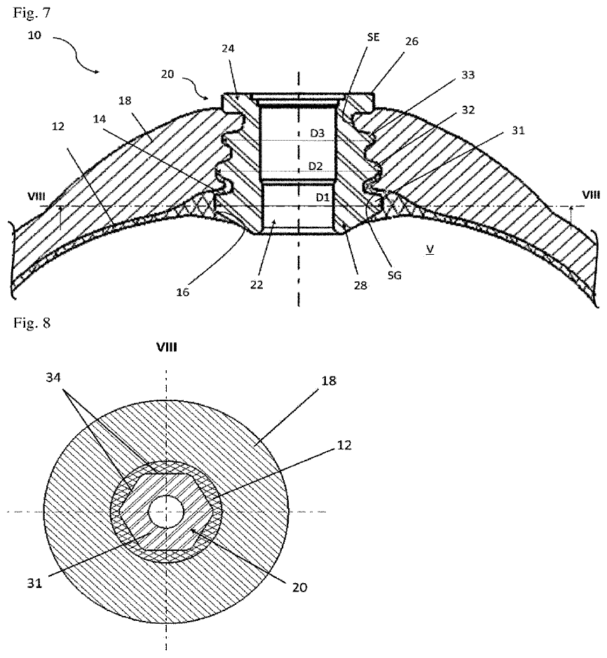

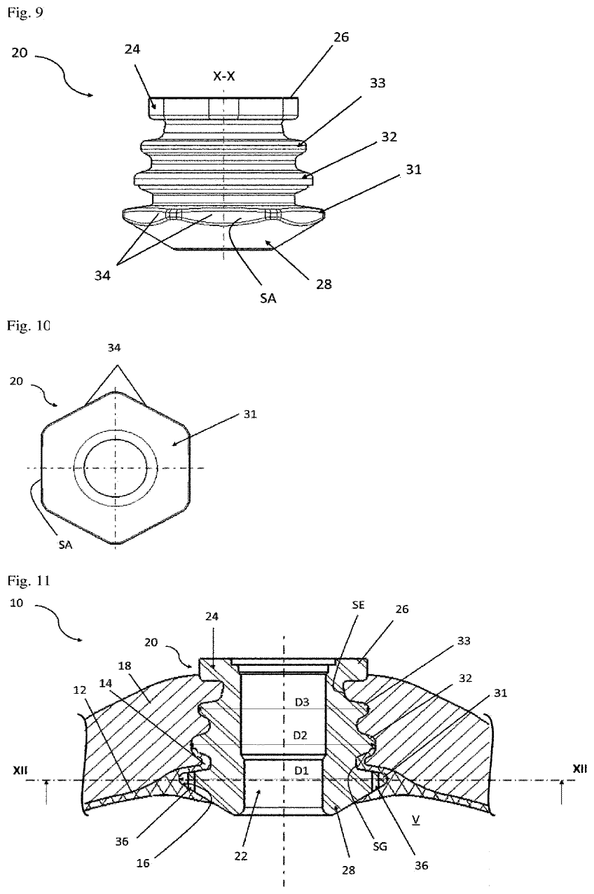

In a fourth embodiment shown in FIGS. 7 to 10, the first annular protrusion 31 has a hexagonal cross-section in a plane perpendicular to the main axis X-X, in this case the plane of its largest diameter, that is, the plane VIII-VIII.

As can be seen in FIGS. 8 and 10, the first annular protrusion 31 thus has six substantially flat faces 34, symmetrically distributed about the main axis X-X, which together form an external anchoring surface SA that is not rotationally symmetrical about the main axis X-X.

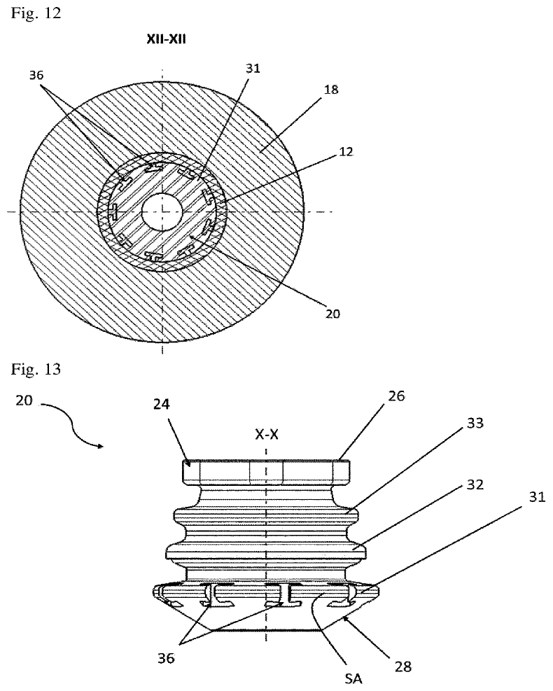

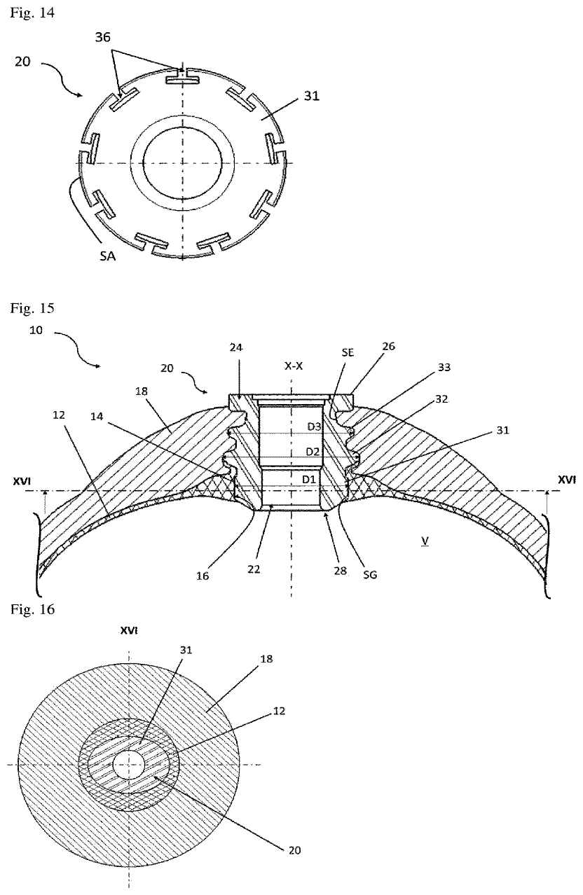

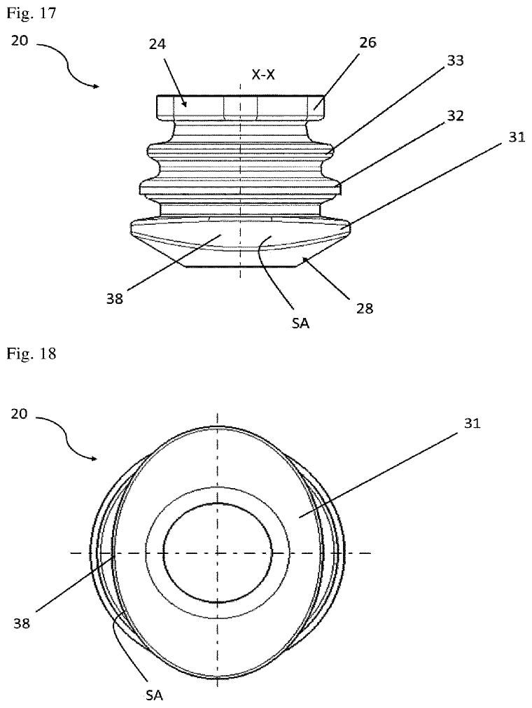

In a fifth embodiment shown in FIGS. 11 to 14, the first annular protrusion 31 comprises a plurality of side notches 36 around its circumference. Here, the side notches 36 have a T-shaped cross-section in a plane perpendicular to the main axis X-X, in this case the plane of its largest diameter, in this case the plane XII-XII, as shown in FIG. 14. Viewing the endpiece 20 from the side, as in FIG. 13, the side notches 36 are shaped like a capital I. The side notches 36 are preferably symmetrically distributed about the axis X-X. There are nine of them, for example, but of course this number may vary.

The first annular protrusion 31 thus has an external anchoring surface SA that is not rotationally symmetrical about the main axis X-X.

In a sixth embodiment shown in FIGS. 11 to 14, the first annular protrusion 31 has an oval-shaped cross-section in a plane perpendicular to the main axis X-X, in this case the plane of its largest diameter, that is, the plane XVI-XVI.

As can be seen in FIGS. 8 and 10, the first annular protrusion 31 has oblong faces 38, which together form an external anchoring surface SA that is not rotationally symmetrical about the main axis X-X.

We will now describe an example of a method for manufacturing a vessel 10.

In a first step, an endpiece such as the endpiece 20 is provided, that is, extending along a main axis X-X, comprising an axial opening 22, a first annular protrusion 31 extending radially outwards from the vessel 10 with respect to the axial opening 22, a second annular protrusion 32 extending radially outwards from the vessel 10 with respect to the axial opening 22, the second annular protrusion 32 being intended to be arranged axially outwards from the vessel 10 with respect to the first annular protrusion 31, and an outer axial end 24 intended to extend at least partially outside the vessel 10.

In the case where the endpiece 20 comprises an external anchoring surface SA comprising a roughened surface, the latter is obtained by a step selected from etching of the external anchoring surface SA of the endpiece, machining of the external anchoring surface SA of the endpiece, molding of the external anchoring surface SA of the endpiece, knurling of the external anchoring surface SA of the endpiece and a combination of these steps, wherein the non-rotationally symmetrical surface about the main axis of the endpiece X-X is obtained by machining and/or molding the external anchoring surface SA of the endpiece, and wherein the adhesive surface of the endpiece is obtained by depositing on the external anchoring surface SA of the endpiece an adhesive or by activating the external anchoring surface SA of the endpiece. The external surface SA of the endpiece can be etched, for example, using a chemical etchant or a laser. The adhesive surface of the endpiece can be deposited by spraying or injection molding. Activation of the external anchoring surface SA of the endpiece can be achieved by plasma, laser or heating.

A generally cylindrical liner 12, extending along an axis X-X is then produced. This liner 12 comprises a neck 14 surrounding an axial orifice 16 of the liner 12. The liner 12 is made of plastic, for example, and is preferably extrusion blow-molded.

The endpiece 20 is then attached to the liner 12, so that the endpiece 20 is at least partially provided in the neck 14 of the liner 12 and the neck 14 extends along the main axis X-X, and so that a sealing contact surface SG is created between the endpiece 20 and the neck 14 of the liner 12, which extends between the first annular protrusion 31 and the second annular protrusion 32. This step of attaching the endpiece 20 to the liner 12 may include a step of overmolding the neck 14 of the liner 12 onto the external anchoring surface SA of the endpiece during the liner 12 manufacturing step.

In one variant, the endpiece 20 is attached to the liner 12 by overmolding an intermediate layer of plastic material chemically compatible with the plastic material of the liner 12 onto the external anchoring surface SA of the endpiece, the intermediate layer preferably being manufactured by injection molding, and by overmolding the neck 14 of the liner 12 onto the intermediate layer of plastic material during the step of manufacturing the liner 12.

A reinforcing shell 18 is then attached to the liner 12 and the endpiece 20, so that the reinforcing shell 18 covers the liner 12, and so as to create a contact surface SE between the endpiece 20 and the reinforcing shell 18, which extends axially between the second annular protrusion 32 and the outer axial end 24 of the endpiece 20. Preferably, the reinforcing shell 18 is made of a composite material comprising resin and reinforcing fibers.

Preferably also, the attachment of the reinforcing shell 18 to the endpiece 20 and to the liner 12 is a filament winding step of the reinforcing shell 18 onto the liner and the endpiece 20 during the step of manufacturing the reinforcing shell 18.

The invention is not limited to the embodiments presented, and other embodiments will become clearly apparent to the person skilled in the art. In particular, the largest diameters of the first, second and third annular protrusions can be varied in the fourth, fifth and sixth embodiments in the same way as in the first, second and third embodiments.

### LIST OF REFERENCES

10: Vessel

12: Liner

14: Neck

16: Axial orifice of the liner

18: Reinforcing shell

20: Endpiece

22: Axial opening of endpiece

24: Outer axial end of endpiece

26: Annular shoulder of the endpiece

28: Inner axial end of endpiece

29: Teeth of the first annular protrusion

31: First annular protrusion of endpiece

32: Second annular protrusion of endpiece

33: Third annular protrusion of endpiece

34: Faces of the hexagon

36: Side notches

38: Oblong faces

D1: Larger diameter of first annular protrusion

D2: Larger diameter of second annular protrusion

D3: Larger diameter of third annular protrusion

V: Internal volume of vessel

SA: External anchoring surface of endpiece

SE: Contact surface between endpiece and reinforcing shell

SG: Sealed contact surface between neck and endpiece

X-X: Vessel main axis

1-14. (canceled)

15. A vessel for containing a pressurized gas comprising:
a generally cylindrical plastic liner extending along a main axis, comprising a neck surrounding an axial orifice of the liner;
a reinforcing shell covering the liner; and
an endpiece extending along the main axis at least partially provided in the neck, the endpiece comprising at least:
an axial opening,
a first annular protrusion extending radially outwards from the vessel with respect to the axial opening,
a second annular protrusion extending radially outwards from the vessel with respect to the axial opening, the second annular protrusion being arranged axially outwards from the vessel with respect to the first annular protrusion, and
an outer axial end extending at least partially outside the vessel,
wherein the liner extends from the first annular protrusion to the second annular protrusion, covering at least a portion of the first annular protrusion, and
wherein the vessel further comprises a sealing contact surface between the endpiece and the neck of the liner, which extends between the first annular protrusion and the second annular protrusion, and a contact surface between the endpiece and the reinforcing shell, which extends axially between the second annular protrusion and the outer axial end of the endpiece.

16. The vessel according to claim 15, wherein the neck of the liner extends axially outwards from the vessel with respect to the axial orifice of the liner.

17. The vessel according to claim 15, wherein the liner covers at least a portion of the second annular protrusion.

18. The vessel according to claim 15, wherein the liner completely covers the first annular protrusion.

19. The vessel according to claim 15, wherein the contact surface between the endpiece and the reinforcing shell extends axially from the second annular protrusion to the outer axial end of the endpiece.

20. The vessel according to claim 15, wherein a larger diameter of the first annular protrusion is smaller than or equal to a larger diameter of the second annular protrusion.

21. The vessel according to claim 15, wherein a larger diameter of the first annular protrusion is strictly greater than a larger diameter of the second annular protrusion.

22. The vessel according to claim 15, wherein the endpiece further comprises a third annular protrusion extending radially outwards from the vessel with respect to the axial opening, the third annular protrusion being arranged axially outwards from the vessel with respect to the second annular protrusion.

23. The vessel according to claim 15, wherein the endpiece further comprises an external anchoring surface selected from a group comprising a roughened surface, a surface which is not rotationally symmetrical about the main axis, an adhesive surface and a combination of these surfaces, the external anchoring surface of the endpiece being a sealed contact surface between the endpiece and the neck of the liner and/or a contact surface between the endpiece and the reinforcing shell.

24. A method for manufacturing a vessel for containing a pressurized gas, the method comprising the following steps:
supplying an endpiece extending along a main axis, comprising an axial opening, a first annular protrusion extending radially outwards from the vessel with respect to the axial opening, a second annular protrusion extending radially outwards from the vessel with respect to the axial opening, the second annular protrusion being configured to be arranged axially outwards of the vessel with respect to the first annular protrusion, and an outer axial end configured to extend at least partially outside the vessel;
manufacturing a generally cylindrical liner extending along an axis, the liner comprising a neck surrounding an axial orifice of the liner;
attaching the endpiece to the liner, so that the endpiece is at least partially provided in the neck of the liner and the neck extends along the main axis, and so as to create a sealed contact surface between the endpiece and the neck of the liner, which extends between the first annular protrusion and the second annular protrusion, and
attaching a reinforcing shell to the liner and to the endpiece, so that the reinforcing shell covers the liner, and so as to create a contact surface between the endpiece and the reinforcing shell which extends axially between the second annular protrusion and the outer axial end of the endpiece.

25. The method according to claim 24, wherein the liner is made of plastic and the endpiece comprises an external anchoring surface selected from a group comprising a rough surface, a surface which is not rotationally symmetrical about the main axis, an adhesive surface and a combination of these surfaces, and wherein the step of attaching the endpiece to the liner comprises a step of overmolding the neck of the liner onto the external anchoring surface of the endpiece during the step of manufacturing the liner.

26. The method according to claim 25, wherein the liner is manufactured by extrusion blow molding.

27. The method according to claim 25, wherein the roughened surface of the endpiece is obtained by a step selected from etching of the outer anchoring surface of the endpiece, machining of the outer anchoring surface of the endpiece, molding of the outer anchoring surface of the endpiece, knurling of the outer anchoring surface of the endpiece and a combination of these steps, wherein the non-rotationally symmetrical surface about the main axis of the endpiece is obtained by machining and/or molding the external anchoring surface of the endpiece, and wherein the adhesive surface of the endpiece is obtained by depositing on the external anchoring surface of the endpiece an adhesive or by activating the external anchoring surface of the endpiece.

28. The method according to claim 24, wherein the liner is made of plastic and the endpiece comprises an external anchoring surface selected from a group comprising a roughened surface, a surface which is not rotationally symmetrical about the main axis, an adhesive surface and a combination of these surfaces, and wherein the step of attaching the endpiece to the liner comprises the following steps:
overmolding, onto the external anchoring surface of the endpiece, an intermediate layer of plastic material chemically compatible with the plastic material of the liner, and
overmolding of the neck of the liner onto the intermediate layer of plastic material during the liner manufacturing step.

29. The method according to claim 28, wherein the intermediate layer is produced by injection molding and the liner is manufactured by extrusion blow molding.

30. The method according to claim 28, wherein the roughened surface of the endpiece is obtained by a step selected from etching of the outer anchoring surface of the endpiece, machining of the outer anchoring surface of the endpiece, molding of the outer anchoring surface of the endpiece, knurling of the outer anchoring surface of the endpiece and a combination of these steps, wherein the non-rotationally symmetrical surface about the main axis of the endpiece is obtained by machining and/or molding the external anchoring surface of the endpiece, and wherein the adhesive surface of the endpiece is obtained by depositing on the external anchoring surface of the endpiece an adhesive or by activating the external anchoring surface of the endpiece.

31. The method according to claim 24, wherein the reinforcing shell is made of a composite material comprising a resin and reinforcing fibers, the step of attaching the reinforcing shell to the endpiece and to the liner is a step of filament-winding the reinforcing shell onto the liner and the endpiece during the step of manufacturing the reinforcing shell.
